(19) United States
(12) Patent Application Publication
(10) Pub. No.: US 2001/0007483 A1
(43) Pub. Date: Jul. 12, 2001

(54) Circuit for convergence setting in a projection television display

(76) Inventors: Jacques Chauvin, Monchweiler (DE); Bernhard Malota, Monchweiler (DE); Albert Runtze, Villingen-Schwenningen (DE)

Correspondence Address: Joseph S. Tripoli, Thomson multimedia Licensing Inc., Patent Operation, Two Independence Way, P.O. Box 5312, Princeton, NJ, 08543-5312, US

(21) Appl. No.: 09/731,492

(22) Filed: Dec. 7, 2000

Related U.S. Application Data
(63) Continuation-in-part of application No. 09/007,986, filed on Jan. 16, 1998, now abandoned.

(30) Foreign Application Priority Data
Feb. 24, 1997 (DE) 197 02 452.7

(51) Int. Cl. H04N 17/00; H04N 17/02; H04N 3/22

(52) U.S. Cl. 348/745; 348/189

(57) ABSTRACT

A Circuit for convergence setting in a projection television display, having a display screen with a photosensor for detecting impingement of a marker contained in a projected picture. The photosensor generates an output signal having a specific time characteristic. The circuit comprises an integrating element coupled to receive the output signal from the sensor when impinged by a blue marker. The integrating element is dimensioned in such a way that the time characteristic of the output signal of the sensor when impinged by the blue marker is approximately equal to the time characteristic of output signals from the sensor when impinged by a red or green marker.

### CROSS-REFERENCE TO RELATED APPLICATION

This application is a continuation in part of application Ser. No. 09/007,986 filed Jan. 16, 1998.

BACKGROUND OF THE INVENTION.

This invention relates to the field of projected raster scanned image display and in particular to the automated measurement and correction of convergence errors in the projected display image.

A projection television set contains three monochrome picture tubes for the primary colors red, green, blue, which each project a picture in its color onto a screen. The three pictures are superposed on the screen and together produce a color picture. For satisfactory picture reproduction, the three pictures projected onto the screen must be brought exactly into congruence, i.e. converge. Additional deflection circuits and correction coils for the horizontal direction and the vertical direction and for the colors R, G, B are used in convergence setting. The correction currents for the convergence are taken from digital memories in which correction values for the pixels are stored.

When such devices are manufactured, use is made of a large number of photosensors positioned at the periphery the visible picture area during convergence adjustment. The projected picture from each of the three tubes contains so-called markers in the form of monochrome red, green or blue picture blocks. For satisfactory convergence, these projected markers must impinge exactly on each assigned sensor. This means that a manipulated variable or signal which indicates the two conceivable states “no light on the sensor” and “light on the sensor” has to be obtained from the output signal of each sensor. It has been shown that the time characteristic, or build up and decay lag, of the output signal of a sensor during illumination by the marker image varies on account of different persistence of the individual phosphors for red, green and blue cathode ray tubes. In particular, during the impingement of the marker on the sensor, the sensor for the color blue supplies a significantly shorter and steeper output signal having a higher amplitude in comparison with the sensor signals for green and red illumination. This means that different evaluation circuits have to be provided for the output signals of the individual sensors or a common evaluation circuit must be switched over between the individual primary colors R, G, B. This necessity increases the circuitry for evaluating the output signals of the sensors.

### SUMMARY OF THE INVENTION

This invention simplifies the overall circuit for evaluating the output signals from the individual sensors and ensures correct detection of the presence of light, i.e. illumination of the sensor by the marker image. A Circuit for convergence setting in a projection television display, having a display screen with a photosensor for detecting impingement of a marker contained in a projected picture. The photosensor generates an output signal having a specific time characteristic. The circuit comprises an integrating element coupled to receive the output signal from the sensor when impinged by a blue marker. The integrating element is dimensioned in such a way that the time characteristic of the output signal of the sensor when impinged by the blue marker is approximately equal to the time characteristic of output signals from the sensor when impinged by a red or green marker.

The invention consequently consists in the fact that an integrating element ties in the path of the output signal of the sensor for the colour blue and is dimensioned in such a way that the time characteristic of the output signal of the sensor for the color blue is approximately equal to that of the output signals for the colors red and green.

In the solution according to the invention, the output signals from the three sensors for the primary colors R, G, B are brought in a simple manner to approximately the same waveform, i.e. the same time characteristic during the impingement of the marker on the sensor. This affords the advantage that the output signals of the sensors can be analyzed and processed similarly. This simplifies the overall circuit because the same circuits can be used for the three primary colors or else the output signals for the three primary colors can be processed using the same circuit given sequential evaluation of the color signals.

In a development of the invention, circuit means for suppressing the DC voltage component are in each case provided in the path of the output signal of a sensor, only the AC voltage component of the signal being evaluated in the circuit for evaluating the output signal of a sensor. As a result of this solution, signal components in the output signal of the sensors on account of continuous or ambient light which negatively influence the evaluation of the signals are eliminated.

In another development of the invention, the output signal of the sensor is applied to the input of a monostable multivibrator, the duration of whose period is somewhat longer than the duration of a field. The output signal of the monostable multivibrator is sampled repeatedly during the duration of a frame and a manipulated variable indicating light is generated only when the output signal of the monostable multivibrator has the value “1” for “light on the sensor” for the duration of two or more display frames. This solution prevents interference pulses which occur only momentarily in a picture from triggering the circuit and emitting an output voltage which indicates a marker that is not present.

In a further embodiment of the invention, a plurality sensors located at the periphery of the screen are connected in parallel. This simplifies the circuit and the wiring. The number of sensors connected in parallel is limited only by the capacitance added by each sensor in the circuit. If the number of sensors is relatively large, the sensors can also be divided into groups each having a number of parallel sensors. However, providing the marker is controllably positioned to illuminate individual sensors determination of color signal processing is simplified. The sensor signals then appear on a line sequentially as illuminated and can fed changeover switches to the separate evaluation circuits for the primary colors.

### BRIEF DESCRIPTION OF THE DRAWINGS

FIG. 1 shows the fundamental structure of the projection television display with automatic convergence adjustment.

FIGS. 2-4 show signal amplitude characteristics of the output signals of the sensors with and without application of the invention.

FIGS. 5, 6 respectively depict a sensor signal subject to continuous-light and an embodiment for the suppression thereof.

FIG. 7 shows an evaluation circuit with a monostable multivibrator for an interference pulse.

FIG. 8 shows the solution according to FIG. 7 for a useful pulse.

FIG. 9 shows a simplified block diagram of the inventive convergence correction circuit.

### DETAILED DESCRIPTION

FIG. 1 shows the structure of a projection television display in a simplified form. Three monochrome picture tubes project scanned rasters for the primary colors R, G, B onto the screen 1, where they are superposed to form a color picture. For superposition of this type, the convergence of the three projected rasters must be correct, i.e. mutually corresponding parts of the three rasters must coincide at every point on the screen. In order to set the correct convergence, an exemplary single sensor S, in the form of a photodiode, is assigned to screen 1 and located at the periphery of the visible picture area. In reality a plurality of sensors can be used located at predetermined peripheral screen locations. The picture projected onto the screen 1 contains a marker image M in the form of a monochrome, or red, green or blue, picture block positioned within a picture area that is black in the setting region of the marker M. For satisfactory convergence, the marker M must impinge on or illuminate the sensor S. This illumination is detected by the fact that when the marker image M sweeps over the sensor S, the latter generates an output signal U1. An evaluation circuit 3 evaluates sensor signal U1 forming an output signal U2 having an output value “1” when the sensor is lit by marker M. If the marker M fails to illuminate sensor S, the sensor S is unlit and evaluation circuit 3 generates an output signal having a value “0” “representing a dark” or unlit sensor.

When marker image M sweeps over sensor S, light 2 illuminates sensor S. The output signal U1 of the sensor S passes to the detection circuit 3, which evaluates the output voltage U1 and generates a binary output signal U2, namely U2=“0”=“no light or dark”, i.e. the marker M does not impinge on the sensor S, and U2=“1”=“light”, i.e. the marker M impinges on the sensor S. The binary output signal from the output of the circuit 3 passes to the microprocessor or personal computer 4, which evaluates the binary signal U2 and forwards it to the digital convergence circuit (DKS) 5. The digital convergence circuit 5 operates in such a way that digital convergence values at the sensor location are stored for the individual R, G, B, color rasters or images. These stored digital convergence values for the individual color rasters are converted into analog convergence signals by digital/analogue conversion and are coupled to convergence coils Rc, Gc and Bc to provide convergence of the three images.

The marker block signal is controllably inserted into each red green and blue video display signal for coupling to each respective CRT for display. Thus for example, when only the marker block is inserted in the red video display signal by inserter 5, only a red marker block will be projected to illuminate photosensor S, and the resulting sensor signal measurements will be stored specific to correction of the red projected image. Similarly the green and blue video display signals in turn have the marker block inserted and the respective sensor signal measurements are stored specific to correction of the individual color images.

Operation of the automatic convergence correction system will be described in only general terms because in this disclosure applicants identify and resolve differences in cathode ray tube phosphor build up and decay lag. In FIG. 1 an exemplary single sensor S is depicted adjacent to an edge of screen 1. However a plurality of sensors, for example four or more, can be employed positioned at the periphery of the screen. Because the physical location of each sensor of the plurality is known, (fixed and predetermined), the marker block signal can be controllably generated and inserted into each color display signal by means of computer 4 and inserter 50. For example if convergence errors in the red raster image are to be measured and corrected marker block is generated and inserted in the red CRT video input signal. The marker block is controllably positioned within the red raster to locate the block such that the projected block image illuminates the sensor S. If the red raster image is free from convergence errors the block M will be detected by the sensor. However if the sensor fails to detect the projected image of the block then a convergence error is present in the red raster and the block position is moved or swept until the sensor is lit and it signals detection. The convergence error is represented by the difference between the predetermined position of the marker block and the actual detected marker position. Clearly accurate convergence measurement requires that the color image intensity rise and fall times are advantageous equalized as disclosed by applicants.

FIG. 2 shows the signal amplitude versus time characteristic of the output signal U1RG of sensor S when illuminated by marker image sweeps generated by respective red and green cathode ray tubes. The time characteristic of U1 is substantially similar for these two colors. Symbol T designates the duration of a picture during deflection.

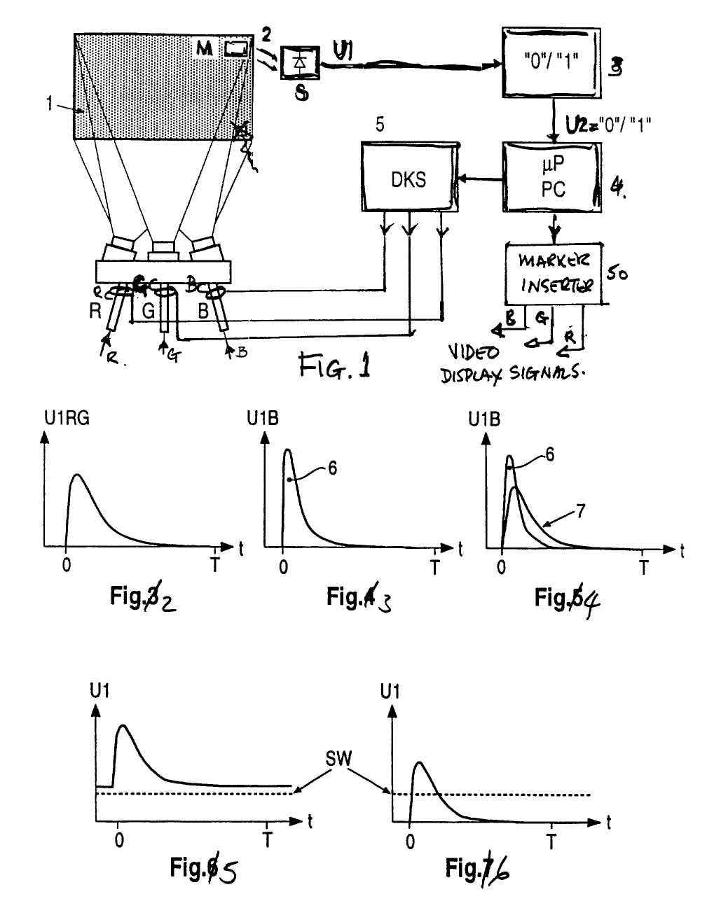

FIG. 3 shows waveform 6, the amplitude versus time characteristic of signal U1B resulting from illumination by a marker image sweep generated by the blue cathode ray tube. When compared with red and green signal responses, the signal response characteristic of U1B resulting from blue illumination has a significantly higher amplitude and a significantly shorter duration than signal U1RG formed by the red and green CRT light. Thus with blue light illumination the pulse signal U1B at the output of the sensor S is therefore significantly steeper, shorter and larger.

In FIG. 4, blue light pulse 6 is depicted and is subject to integration resulting in the signal depicted as pulse 7. Thus advantageous integration of the blue CRT pulse image yields a response characteristic substantially similar to that generated by the red and green CRTs and depicted as signal U1RG in FIG. 2. The output signals of the sensors for red, green and blue then have, to the greatest possible extent, substantially similar time characteristic, with the result that these pulses can be evaluated by either identical circuits or by using the same circuit.

In FIG. 5, the characteristic of the output signal U1 includes an appreciable DC voltage component on account of ambient light that is generally present illuminating the sensor. Evaluation of this signal at the threshold value SW would then be impossible, since the marker signal part of signal U1 always lies above the threshold value SW on account of the DC voltage component.

In FIG. 6, the DC voltage component shown in FIG. 6, and caused by continuous light is eliminated by AC voltage coupling or other circuit measures. The result of this is that the output signal U1 can be evaluated at the threshold value SW. For example, a positive pulse is generated as long as U1 lies above the threshold value SW.

FIG. 7 shows the method of operation of a circuit for evaluating the output signal U1 of the sensor S for an interference pulse 8. The interference pulse 8 passes to the input of a monostable circuit which, on account of the pulse 8, generates an output pulse U2 having the duration D1, which is somewhat longer than the duration T of a display frame. According to FIG. 7c, this output signal U2 is sampled at equidistant values, as is illustrated by the “1” in each case. In this case, the monostable circuit supplies only three samples because the pulse U2 has ended at the next, that is to say fourth, sampling. The evaluation circuit is dimensioned in such a way that it responds only in the event of a number of more than three samples, that is to say more than three times U2=1. Since the one-off triggering of the monostable circuit by the interference pulse 8, which occurs only once, supplies only three samples “1”, the interference pulse 8 is consequently suppressed and does not generate an output signal which indicates the impingement of a marker M on a sensor S.

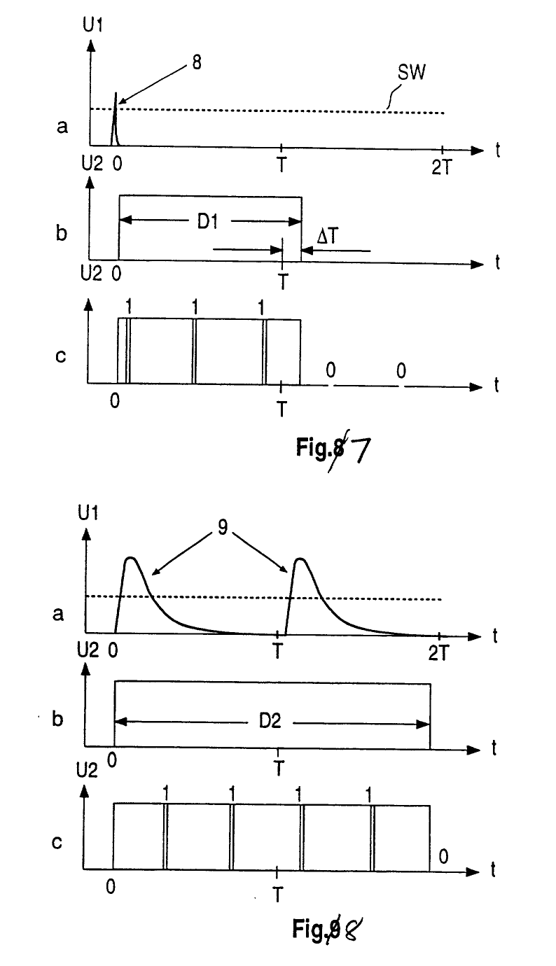

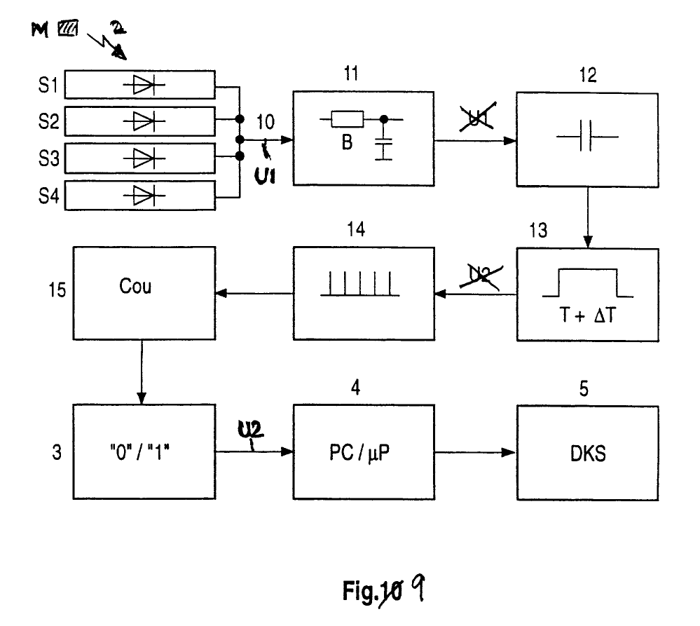

FIG. 8 shows the same conditions for a useful pulse 9, which is triggered by the impingement of the marker M on the sensor S and is therefore repeated with the period T. Before the output voltage U2 of the monostable circuit can be reset after the duration D1 as in FIG. 7b, it is set anew by the second pulse 9 and therefore assumes the longer duration D2 according to FIG. 8b. The equidistant sampling, performed as in FIG. 7c, of the pulse U2 according to FIG. 8c now produces four samples, in other words more than three. The circuit recognizes from this that what is involved is a useful pulse on account of a marker M, and feeds this pulse to the further evaluation circuit. In this way an interference pulse 8 can be identified and suppressed and equally a useful pulse 9 can be identified and evaluated.

FIG. 9 shows a simplified block diagram for the evaluation according to FIGS. 8 and 9. Four exemplary sensors S1-S4, for example, positioned adjacent the screen periphery, are connected in parallel and when triggered by sequential marker illumination generate output pulses on line 10. For example, when the sensors are illuminated by a blue marker image the sensor output signals, for example signal U1 from sensor S1, is integrated by circuit block 11 to produce a time characteristic as depicted by curve 7 of FIG. 4. However, for the reasons previously explained, during red and green sensor illumination, such inventive integration is not required. In circuit block 12, a DC voltage component dc of the signal from the output of the circuit block 11 is suppressed and only the AC voltage component is evaluated, as explained in FIGS. 5 and 6. The evaluation in accordance with FIGS. 7 and 8 is effected in the monostable circuit 13 with the toggle duration T+ΔT. The output signal U2 of the monostable circuit 13 is sampled in accordance with FIGS. 7c and 8c in the sampling circuit 14. The counter (Cou) 15 counts the number of samples “1” in accordance with FIGS. 7c and 8c. The circuit block 3 makes the binary decision “0”=“dark”, no marker lighting or impinging on the sensor and “1”=“light”=marker impinges more or less on the sensor.

The personal computer or microprocessor 4 processes these signals using a correction algorithm which determines the convergence error and sequences the marker block position to illuminate each exemplary sensor for each CRT display. The output signal of the circuit 4 controls the digital convergence circuit 5 which forms analog convergence correction signals for coupling to the correction coils.

What is claimed is

1. A circuit for convergence setting in a projection television display, having a display screen with a photosensor for detecting illumination by a marker contained in a projected picture, said photosensor generating an output signal having a specific time characteristic, said circuit comprising; an integrating element coupled to receive said output signal from said sensor when illuminated by a blue marker, said integrating element being dimensioned in such a way that said time characteristic of said output signal of said sensor when illuminated by said blue marker is approximately equal to said time characteristic of output signals from said sensor when illuminated by a red or green marker.

2. The circuit according to claim 1, further comprising, coupling means receiving said output signal for suppressing a DC voltage component of said output signal.

3. The circuit according to claim 1, wherein only an AC voltage component of said output signal is evaluated in a circuit for evaluating said output signal of said sensor.

4. The circuit according to claim 1, wherein said output signal of said sensor is coupled to trigger a monostable multivibrator having a period greater than a frame duration.

5. The circuit according to claim 4, wherein an output signal of said monostable multivibrator is sampled repeatedly during said frame duration and a manipulated variable is generated only when said output signal of said monostable multivibrator has a value “1” for a duration of two or more frames.

6. The circuit according to claim 1, further comprising, a plurality sensors connected in parallel and positioned adjacent to edges of said display screen.
